(19) United States
(12) Patent Application Publication
(10) Pub. No.: US 2010/0173545 A1
(43) Pub. Date: Jul. 8, 2010

(54) ELEMENT OF CHANGING A SURFBOARD TAIL AND METHOD TO SET IT UP

(76) Inventor: Marcelo Jose Quadrini Castanho, Ubatuba (BR)

Correspondence Address: BLACK LOWE & GRAHAM, PLLC, 701 FIFTH AVENUE, SUITE 4800, SEATTLE, WA, 98104, US

(21) Appl. No.: 12/294,863

(22) PCT Filed: Mar. 29, 2006
(86) PCT No.: PCT/BR2006/000059

§ 371 Date: Sep. 26, 2008

(51) Int. Cl. B63B 35/79; B23P 6/00

(52) U.S. Cl. 441/74; 29/402.09; 29/402.15

(57) ABSTRACT

Through which it will be possible the change of different parts that will provide, on just one surfboard, vary the tail format in a way that it could incorporate tails with pin, round, swallow, and other formats, giving a major diversification to the use of the sport equipment, according to the conditions of the sea and/or the operations that the athlete would like to execute in the projection of the wave line, so this element will be installed in the back part of the block of the board shaped and adjusted in relation to the lines of shape, so that, after the lamination, the so called change could turn an integrated part, the setting up of this element will provide a faster, simpler and quicker way the replacement of format of the tail with the objective to change the line of the format of the rear part of the surfboard, transforming it according to the needs of the athlete and done by himself before starting the practice and also according to the sea conditions, so that he could do with a simple tool the necessary changes due to the alterations of the sea and wouldn't need to go out of the water to change the tail more adequate to the new conditions or according to hi set of movements to do.

### BACKGROUND OF THE INVENTION

There is no news in the current state of the art of any development, related to production of surfboards, which permits an alteration of the tail format, what obliges the practitioners of the most advanced levels of the sport to acquire a quiver of boards, that is, according to his weight and height, the athlete chooses the type of board that better fits his style and his experience style so it could be a short board type or a little board whose main characteristic is the speed or the fun board type, which more used by beginners in the sport, or the long board type or big boards which are used by the most experienced, however, for the execution of some operations, in different sea conditions, the athlete needs, necessarily, to have with him, different boards with different tail formats, what besides being expensive, needs space for the transportation of the boards having even, according the change of the sea, the necessity to change constantly the equipment.

### SUMMARY OF THE INVENTION

The current descriptive report refers to an ELEMENT OF CHANGING THE SURFBOARD TAIL AND THE METHOD OF SETTING UP THE ELEMENT OF CHANGING THE SURFBOARD TAIL, that uses an element through which it is possible the change of different parts that will provide, on just one surfboard, vary the tail format in a way that it could incorporate tails with pin, round, swallow, and other formats, giving a major diversification to the use of the sport equipment, according to the conditions of the sea and/or the operations that the athlete would like to execute in the projection of the wave line, so this element will be installed in the back part of the block of the board shaped and adjusted in relation to the lines of shape, so that, after the lamination, the so called change could turn an integrated part of the surfboard.

The changeable element of the tail of the surfboard, formerly proposed, will be provided in three standardized dimensions; those of the smallest are usually used in surfboards of the short boards class; the average dimension is usually used in surfboards of the fun boards class; however, this correspondence relationship can be altered according to the physical characteristics of the athlete and his preference for a chosen surfboard class, taking into consideration that after obtaining the final shape of the block of a surfboard, produced according to the weight and the height of the athlete and with the tail of his choice, this will have, before its lamination phase, the back sectioned to permit the incorporation of the of the changeable element and afterwards getting the conformed group to obtain the perfect lining among the lines of the shape of the block of the board and of the changeable element, all of which, after the lamination phase are rigidly integrated among them, forming a surfboard prepared with regular and continuous slippery lines, offering a mechanical resistance adequate to bear the strengths of the sea as a result of the movements which are executed. In the line of the wave projection so as the forces resultant from the impact of the lower part of the surfboard especially the back part against the masses of water of the wave, that happens in the most radical drills where the boards projects to the high part and returns with its lower surface to meet the wave, and so, by means of this element of changing, the athlete could, in a simple practical and quick way change the format of the tail, in a way that the surfboard, originally produced, for example, with a rounded tail, which is recommended practically for all the sizes of tubular and full waves and offers good operation, due to the fact of providing an average stray of the surface, could be substituted by a pin tail, which is the most recommended for tubular and quick, of medium size and big, and that in spite of the possibility of greater speed, it has little mobility because it offers little spray of the surface, could even be replaced by a swallowtail type, which is recommended for tubular and full waves of small size and has operability due to provide a big spray of the surface and faces the amount of water because its shortened drawing.

### BRIEF DESCRIPTION OF THE DRAWINGS

Preferred and alternative examples of the present invention are described in detail below with reference to the following drawings:

FIG. 1 illustrates the superior view of the back part of the conventional surfboard with a pin type tail;

FIG. 2 illustrates a superior view of the back of a conventional surfboard with a round type tail;

FIG. 3 illustrates a superior view of the back of a conventional surfboard with a swallow type tail;

FIG. 4 illustrates a view in exploited perspective of the back part of the block of the board shaped, illustrating the element of changing of the tail;

FIG. 5 illustrates a front view of the element of changing of the tail;

FIG. 6 illustrates a back view of the element of changing of the tail;

FIG. 7 illustrates an upper view of the back of the surfboard after lamination, with the element of changing of the tail already installed, indicating the fitting of the piece which will be part of the pin type tail;

FIG. 8 illustrates an upper view of the back part of the surfboard, after lamination, with the element of changing already incorporated, indicating the fitting of the piece which will be part of the round type of the tail; and

FIG. 9 illustrates an upper view of the back of the surfboard after lamination, with the element of changing already incorporated indicating the fitting of the filling piece that will be part of the swallow type tail.

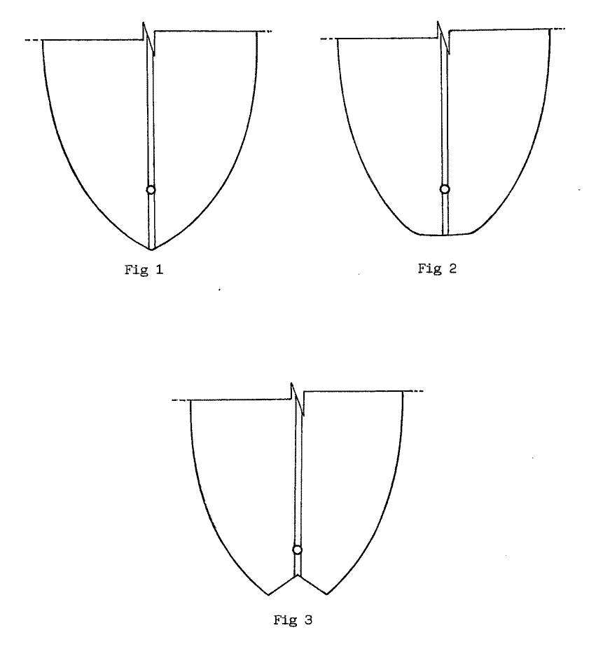

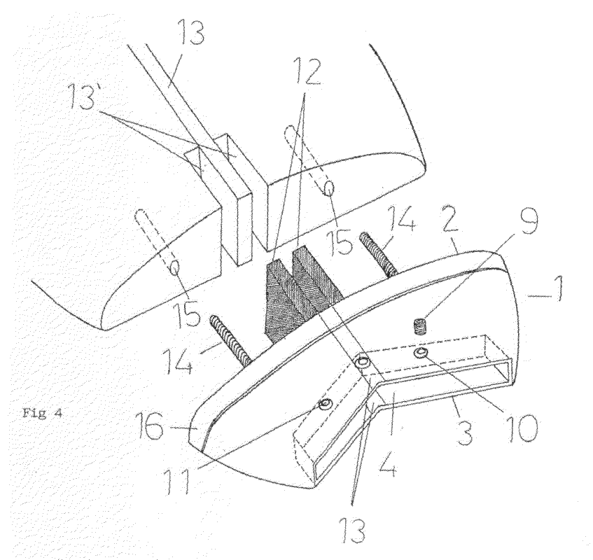

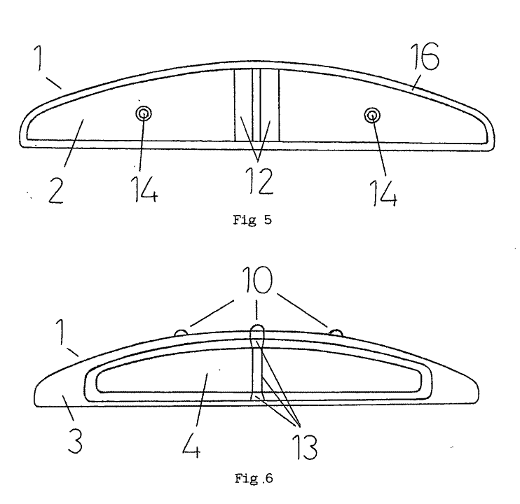

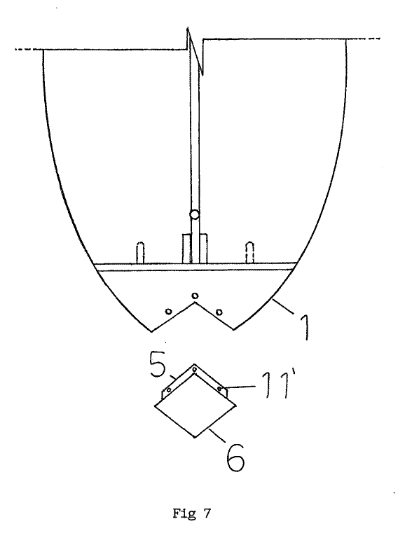

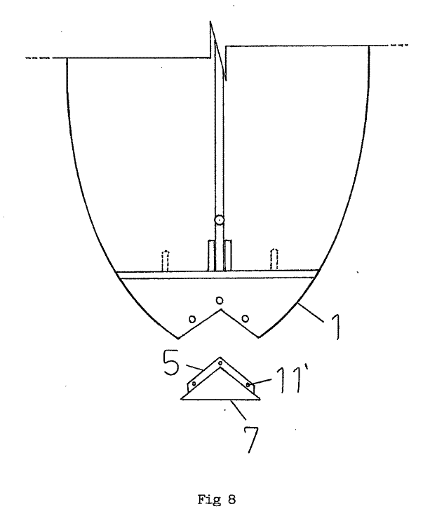

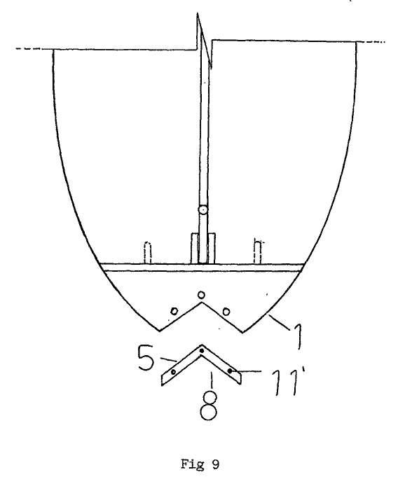

### DETAILED DESCRIPTION OF THE PREFERRED EMBODIMENT

ELEMENT OF CHANGING THE SURFBOARD TAIL AND THE METHOD OF SETTING UP THE ELEMENT OF CHANGING THE SURFBOARD TAIL, that uses an element through which it is possible the change of different parts that will provide, on just one surfboard, vary the tail format in a way that it could incorporate tails with pin, round, swallow, and other formats, giving a major diversification to the use of the sport equipment, according to the conditions of the sea and/or the operations that the athlete would like to execute in the projection of the wave line, so this element will be installed in the back part of the block of the board shaped and adjusted in relation to the lines of shape, so that, after the lamination, the so called change could turn an integrated part of the surfboard.

With the objective of overcome all the inconveniences of the current art, it was idealized and developed the ELEMENT OF CHANGING THE SURFBOARD TAIL AND THE METHOD OF SETTING UP THE ELEMENT OF CHANGING THE SURFBOARD TAIL, proposed before, through which it will be possible, after obtaining the shape of the block of the board, produced according to the athlete's weight and the height, in the type of tail board chosen to fulfill his style and the experience level in the sport, the incorporation of this element will make it possible in a faster, simpler and practical way the replacement of the format of the tail, with the objective of altering the format line of the back of surfboard, transforming it according to the necessity, in a surfboard with round or swallow pin tail; replacement that could be done by the athlete himself, before beginning the practice after evaluating the sea condition or after beginning if there is any change of the sea condition, it will not be necessary to go out of the water but just to have a screwdriver to soften the screws that fix the tail in use and to change it for a more adequate one according to the new sea condition or the operations the athlete might want to do.

According to the figures in the attachment, the ELEMENT OF CHANGING OF THE SURFBOARD TAIL AND THE METHOD FOR THE SETTING UP OF THE ELEMENT OF CHANGING OF THE SURFBOARD TAIL, proposed before is basically constituted of an element through which the change of surfboard tails, which is made of a plastic material preferable polyurethane or polypropylene, and that will be produced in three standard dimensions, the smaller one usually used short board type and the medium one usually used in the fun boards and the biggest used in the long boards; however, this relationship in the correspondence can be altered according to the physical conditions of the athlete and his preference for a type of surfboard so, that element is composed of a body (1) which has the format of swallow type tail with a straight front surface (2) and its back surface in “V” (3) where there is reentrance of fitting (4) that will receive the fitting element (5) of the pieces that form the pin type tail (6) or the round type tail (7). In the case of the swallow type tail, a filling element will be used (8) to close the reentrance of fitting (4) as the body (1) already has the swallow type tail format so the fitting elements (5) in the inner part of that reentrance of fitting (4) is obtained with three screws (9) with no tap and with a crack screwing fitted to prevent accidents, and it is even aided with convex protuberances (10) allocated on the front surface of the body (1) around the holes (11) of reception of such screws (9) which lower extremes in a threading phase controlled by them will slightly penetrate in the circular holes (11) which are considered in the front surface of the fitting element (5) though without trespassing them, so that the fitting element could be retained (5) and consequently, of the pieces that form the pin type tails (6) and the round ones (7) and the filling piece of the swallow type tails (E) even considering on the straight back surface (2) two quadrangular projections (12) allocated paralleled among them and centralized in relation to the back upright (2) and those two projections (12) fitted and fixed by means of a resin, in the cuts (13′) made laterally to the central longer part (13) of the block of the board after obtaining the final shape, having even in the back straight surface (2) pins (14) equidistant in relation to lateral parts of the quadrangular projections (12) in that will be fitted and retained, by means of the resin in the holes (15) made on the upper surface of the block of the board and the external surfaces of such quadrangular projections (12) and the pins (14) are corrugated to give a major adherence to the cured resin and the body (1) will even have along all the extension of its peripheral front border of the cutting (18) that will serve as a means of anchorage of such body (1) on the block of the board when the lamination phase, to provide the finished board with an adequate mechanical resistant for its use.

The method for the incorporation of the element of exchange of the tail of the surfboards presupposes, after obtaining the shape of the block of the board, produced according to the weight and height of the athlete, the class and the his favorite type of tail, the back section of that block, forming a back orthogonal surface where two lateral holes, besides a central quadrangular cut, in the center of which will be located the central long part of the block of the board and in the lateral holes of the back orthogonal surface of the block of the board the lateral pins of the straight back surface of the body of the changeable element will be fitted, while in the spaces located laterally in the central long part of the block of the board the central quadrangular projects of the back surface of the body are fitted and the lateral holes and cuts of the central long part are filled with resin that after being cured will be able to retain the lateral pins and the quadrangular projections of the back straight surface of the body of the element of exchange and so it is aided by the current corrugations in the external surfaces of the lateral pins and the quadrangular projections, after the lines of the surface of the block of the board and the body of the element of change are adjusted between them to obtain the final shape of the total which will be part of the finished board so that at once, the lamination stage could be done in which part of the material of lamination fills the gap formed between prevented cutting along the whole extension of the front peripheral border of the body of the changeable element and the orthogonal back surface of the block of the board, forming an element of anchorage between them.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. (canceled)

2. (canceled)

3. A modifiable surfboard, comprising:
a surfboard having a front and a back, wherein the back includes at least one recess;
a support section having a front surface and a back surface, the front surface of the support section includes at least one protruding element adapted to fit within the at least one recess in the back of the surfboard to fixedly mount the support section to the surfboard and the back surface of the support section having a connection assembly; and
a tail section configured to removably interface with the connection assembly of the support section so as to allow attachment and detachment of the tail section from the support section while the support section is securely mounted to the surfboard.

4. The surfboard of claim 3, wherein:
the back of the surfboard includes a plurality of recesses; and
the front surface of the support section includes a plurality of protruding elements corresponding and adapting to fit within the plurality of recesses in the back of the surfboard to fixedly mount the support section to the surfboard.

5. The surfboard of claim 4, wherein the plurality of protruding elements are fixedly mounted within the plurality of recesses in the back of the surfboard using cured resin.

6. The surfboard of claim 3, wherein the connection assembly of the support section comprises:
at least one recess configured to receive a portion of the tail section; and
at least one screw configured to securely mount the tail section to the connection assembly of the support section.

7. The surfboard of claim 6, wherein a plurality of screws are configured to securely mount the tail section to the connection assembly of the support section.

8. The surfboard of claim 3, wherein the tail section is shaped to provide a pin configuration to the back of the surfboard.

9. The surfboard of claim 3, wherein the tail section is shaped to provide a round configuration to the back of the surfboard.

10. The surfboard of claim 3, wherein the tail section is shaped to provide a swallow configuration to the back of the surfboard.

11. The surfboard of claim 3, wherein the tail section is made out of one of polyurethane or polypropylene.

12. A method for modifying a surfboard, comprising:
determining the desired tail configuration based on at least one of the surfboard user's characteristics and the condition of the sea;
mounting a support section having a front surface and a back surface to the back of the surfboard, the front surface of the support section including at least one protruding element adapted to fit within the at least one recess in the back of the surfboard to fixedly mount the support section to the surfboard and the back surface of the support section having a connection assembly; and
securing a tail section to the connection assembly of the back surface of the support section to provide the desired tail configuration.

13. The method of claim 12, wherein the desired tail configuration comprises at least one of pin, round and swallow.

14. The method of claim 12, wherein:
the back of the surfboard includes at least one recess;
the front surface of the support section includes at least one protruding element corresponding and adapting to fit within the at least one recess in the back of the surfboard to fixedly mount the support section to the surfboard; and
mounting the support section to the back of the surfboard comprises fixedly mounting the at least one protruding element of the support section within the at least one recess in the back of the surfboard.

15. The method of claim 14, wherein:
the back of the surfboard includes a plurality of recesses;
the front surface of the support section includes a plurality of protruding elements corresponding and adapting to fit within the plurality of recesses in the back of the surfboard to fixedly mount the support section to the surfboard; and
mounting the support section to the back of the surfboard comprises fixedly mounting the plurality of protruding elements of the support section within the plurality of recesses in the back of the surfboard.

16. The method of claim 15, wherein the plurality of protruding elements are fixedly mounted within the plurality of recesses in the back of the surfboard using cured resin.

17. The method of claim 12, wherein:
the connection assembly of the support section comprises at least one recess configured to receive a portion of the tail section and at least one screw configured to securely mount the tail section to the support section; and
securing a tail section to the connection assembly of the back surface of the support section to provide the desired tail configuration further comprises mounting at portion of the tail section within the at least one recess of the support section.

18. The method of claim 17, wherein a plurality of screws are configured to securely mount the tail section within the at least one recess of the support section.

19. The method of claim 12, wherein the tail section is made out of one of polyurethane or polypropylene.
